(19) United States
(12) Patent Application Publication
(10) Pub. No.: US 2024/0218221 A1
(43) Pub. Date: Jul. 4, 2024

(54) Moisture-Curable Polyurethane Hot Melt Adhesive Composition

(71) Applicant: Henkel AG & Co. KGaA, Duesseldorf (DE)

(72) Inventors: Haiyan Zhang, Shanghai (CN); Xiaoke Zhang, Shanghai (CN); Dongmei Shen, Shanghai (CN)

(21) Appl. No.: 18/607,736

(22) Filed: Mar. 18, 2024

Related U.S. Application Data
(63) Continuation of application No. PCT/CN2021/121180, filed on Sep. 28, 2021.

(51) Int. Cl. C09J 175/08; B32B 7/12; B32B 17/10; B32B 27/20; B32B 27/36

(52) U.S. Cl. CPC C09J 175/08; B32B 7/12; B32B 17/10; B32B 27/20; B32B 27/365; B32B 2250/02; B32B 2250/244; B32B 2262/101; B32B 2307/54; B32B 2307/558

(57) ABSTRACT

The present invention provides a moisture-curable polyurethane hot melt adhesive composition comprising (A) at least one polyurethane prepolymer obtained by reacting a reactant mixture comprising (A1) a polyol mixture comprising: (a) at least one polyester polyol, and (b) at least one polyether polyol, and (A2) at least one polyisocyanate having at least two isocyanate groups in one molecule; (B) at least one (meth)acrylic polymer present in an amount of no greater than 14% by weight based on the total weight of the adhesive composition, and (C) at least one amorphous polyalphaolefin having a softening point of less than 100° C., present in an amount of no greater than 20% by weight, based on the total weight of the adhesive composition.

### TECHNICAL FIELD

The present invention relates to moisture-curable polyurethane hot melt adhesive compositions, the cured product and the use thereof.

### BACKGROUND OF THE INVENTION

Polyurethane hot melt adhesives are long-established and widespread. In the context of industrial applications, polyurethane hot melt adhesives can be solid at room temperature, melt to a viscous liquid when heated to a moderate temperature, and applied to substrate to be bonded. The molten adhesive composition then cools and solidifies to form initial bond to the substrate. It can further react with moisture to form crosslinking structure and achieve high final strength. Such adhesives consist of a polyol component and an isocyanate component with a functionality of two or more. For numerous applications these adhesives are preferred over other adhesives since the adhesive bonds produced using them are of outstanding bond strength, flexibility, and resistance to shock and fatigue.

Although polyurethane hot melt adhesives provide outstanding adhesive bonds in numerous fields of use, the adhesives of this type that have been known to date are unsuited to the structural adhesive bonding of plastics or metals workpieces, on account of their lack of adequate impact toughness, in particularly, for manufacturing electronic applications that required fast curing, the cured adhesive is difficult to achieve high initial cross tensile strength and outstanding impact resistance simultaneously. This is probably because that a large amount of crystalline polyester polyols is needed to build high initial cross tensile strength, but it decreases the impact resistance property of the adhesive when cured.

In view of the above, there is still a need for a moisture-curable polyurethane hot melt adhesive that exhibits high initial cross tensile strength and excellent impact resistance when cured.

### SUMMARY OF THE INVENTION

According to a first aspect of the invention, disclosed herein is a moisture-curable polyurethane hot melt adhesive composition comprising:
(A) at least one polyurethane prepolymer obtained by reacting a reactant mixture comprising
   (A1) a polyol mixture comprising:
      (a) at least one polyester polyol, and
      (b) at least one polyether polyol, and
   (A2) at least one polyisocyanate having at least two isocyanate groups in one molecule;
(B) at least one (meth)acrylic polymer present in an amount of no greater than 14% by weight based on the total weight of the adhesive composition, and
(C) at least one amorphous polyalphaolefin having a softening point of less than 100° C., present in an amount of no greater than 20% by weight, based on the total weight of the adhesive composition.

According to a second aspect of the invention, provided herein is a method for preparing the moisture-curable polyurethane hot melt adhesive composition.

According to a third aspect of the invention, provided herein is a laminate, comprising a first substrate, a second substrate, and an adhesive layer sandwiched therebetween, wherein the first and second substrates are independently of each other selected from a glass, a resin and a metal, and the adhesive layer being formed by curing the adhesive composition of the present invention.

According to a fourth aspect of the invention, provided herein is an electronic device, comprising the laminate of the present invention or produced using the adhesive composition according to the present invention.

According to a fifth aspect of the invention, provided herein is the use of the adhesive composition according to the present invention or the laminate according to the present invention in manufacturing electronic devices.

Other features and aspects of the subject matter are set forth in greater detail below.

### DETAILED DESCRIPTION OF THE INVENTION

It is to be understood by one of ordinary skill in the art that the present invention is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “at least one” or “one or more” used herein to define a component refers to the type of the component, and not to the absolute number of molecules. For example, “one or more polyols” means one type of polyol or a mixture of a plurality of different polyols.

The term “amorphous” used herein means having no melt transition when measured using Differential Scanning Calorimetry (DSC).

The term “crystalline” used herein means having a melt transition when measured using Differential Scanning Calorimetry (DSC).

The term “room temperature” as used herein refers to a temperature of about 20° C. to about 25° C., preferably about 25° C.

Unless specified otherwise, the recitation of numerical end points includes all numbers and fractions subsumed within the respective ranges, as well as the recited end points.

All references cited in the present specification are hereby incorporated by reference in their entirety.

The molecular weights refer to number average molecular weights (Mn), unless otherwise stipulated. All molecular weight data refer to values obtained by gel permeation chromatography (GPC), unless otherwise stipulated, e.g., according to DIN 55672.

In this context, the glass transition temperature (Tg) or the melting point of a specific polymer is determined using DSC according to DIN 53 765.

The softening point mentioned herein is determined by using Ring and Ball method according to DIN ISO 4625.

Unless otherwise defined, all terms used in the present invention, including technical and scientific terms, have the meaning as commonly understood by one of the ordinary skilled in the art to which this invention belongs.

In one aspect, the present disclosure is generally directed to a moisture-curable polyurethane hot melt adhesive composition comprising:
(A) at least one polyurethane prepolymer obtained by reacting a reactant mixture comprising
   (A1) a polyol mixture comprising:
      (a) at least one polyester polyol, and
      (b) at least one polyether polyol, and
   (A2) at least one polyisocyanate having at least two isocyanate groups in one molecule;
(B) at least one (meth)acrylic polymer present in an amount of no greater than 14% by weight based on the total weight of the adhesive composition, and
(C) at least one amorphous polyalphaolefin having a softening point of less than 100° C., present in an amount of no greater than 20% by weight, based on the total weight of the adhesive composition.

### (A) Polyurethane Prepolymer

According to the present invention, the moisture-curable polyurethane hot melt adhesive composition comprises at least one polyurethane prepolymer obtained by reacting a reactant mixture comprising (A1) a polyol mixture comprising: (a) at least one polyester polyol, and (b) at least one polyether polyol, and (A2) at least one polyisocyanate having at least two isocyanate groups in one molecule.

In some embodiments, the polyurethane prepolymer has a number average molecular weight (Mn) of from 5,000 to 30,000 g/mol, preferably from 8,000 to 20,000 g/mol.

In some embodiments, the component (A) is present in an amount of preferably from 66% to 99% by weight, and more preferably from 70% to 90% by weight, based on the total weight of the adhesive composition.

### (A1) Polyol Mixture

In some embodiments, the polyol mixture (A1) used in the present invention comprises (a) at least one polyester polyol (a).

### (a) Polyester Polyol

Polyester polyols used in the present invention can be selected from solid polyester polyol, liquid polyester polyol, and combinations thereof. The said solid polyester polyol can be crystalline polyester polyol, amorphous polyester polyol, or combinations thereof.

In some embodiments, the crystalline polyester polyols can be used in the present invention which can offer good adhesion strength to the adhesive composition.

Examples of such crystalline polyester polyols can be obtained by ring opening polymerization of a lactone such as ε-caprolactone and/or be derived from diols and diacids. Examples of diols useful in preparing preferred polyester polyols include ethylene glycol, diethylene glycol, 1,3-propylene glycol, 1,4-butanediol, 1,5-pentanediol, 1,6-hexanediol, 1,8-octanediol, 1,10-decanediol, and combinations thereof. Examples of diacids useful in preparing preferred polyester polyols include succinic acid, glutaric acid, adipic acid, suberic acid, azelaic acid, sebacic acid, and 1,12-dodecanedioic acid, dimer acid, and combinations thereof. Included within the scope of useful diacids are various diacid derivatives such as carboxylate esters (especially the methyl and ethyl esters), acid halides (such as acid chlorides) and acid anhydrides, and combinations thereof.

Specific examples of suitable crystalline polyester polyols include poly(hexanediol adipate) polyol, poly(butanediol adipate) polyol, poly-epsilon-caprolactone polyol, poly(hexanediol dodecanedioate) polyol, poly(hexanediol adipic acid terephthalate) polyol, and combinations thereof.

Suitable commercially available crystalline polyester polyols are sold under the DYNACOLL 7300 series of trade designations from Evonik Industries AG including DYNACOLL 7360, 7361, 7362, 7363, 7380, 7390 etc. and under the CAPA series of trade designations from Perstorp Polyols Inc. including CAPA 2201, 2205, 2209, 2302, 2304, 2402 etc. caprolactone polyols.

In some embodiments, the amorphous polyester polyols can also be used in preparing the polyurethane prepolymer in the present invention.

The amorphous polyester polyol includes the reaction product of a polyacid component (e.g., polyacid, polyacid anhydride, polyacid ester and polyacid halide), and a stoichiometric excess of polyol. At least one of the polyacid component and the polyol includes an aromatic group. Suitable polyacids include, e.g., diacids (e.g., dicarboxylic acids), triacids (e.g., tricarboxylic acids), and higher order acids, examples of which include aromatic dicarboxylic acids, anhydrides and esters thereof (e.g. terephthalic acid, isophthalic acid, dimethyl terephthalate, diethyl terephthalate, phthalic acid, phthalic anhydride, methyl-hexahydrophthalic acid, methyl-hexahydrophthalic anhydride, methyl-tetrahydrophthalic acid, methyl-tetrahydrophthalic anhydride, hexahydrophthalic acid, hexahydrophthalic anhydride, and tetrahydrophthalic acid), aliphatic dicarboxylic acids and anhydrides thereof (e.g. maleic acid, maleic anhydride, succinic acid, succinic anhydride, glutaric acid, glutaric anhydride, adipic acid, pimelic acid, suberic acid, azelaic acid, sebacic acid, chlorendic acid, 1,2,4-butane-tricarboxylic acid, decanedicarboxylic acid, octadecanedicarboxylic acid, dimeric acid, dimerized fatty acids, trimeric fatty acids, and fumaric acid), and alicyclic dicarboxylic acids (e.g. 1,3-cyclohexanedicarboxylic acid, and 1,4-cyclohexanedicarboxylic acid), and mixture thereof. Examples of suitable polyols include aliphatic polyols, e.g., ethylene glycols, propane diols (e.g., 1,2-propanediol and 1,3-propanediol), butanediols (e.g., 1,3-butanediol, 1,4-butanediol, and 1,2-butanediol), 1,3-butenediol, 1,4-butenediol, 1,4-butynediol, pentane diols (e.g., 1,5-pentanediol), pentenediols, pentynediols, 1,6-hexanediol, 1,8-octanediol, 1,10-decanediol, neopentyl glycol, diethylene glycol, triethylene glycol, tetraethylene glycol, polyethylene glycols, propylene glycol, polypropylene glycols (e.g., dipropylene glycol and tripropylene glycol), 1,4-cyclohexanedimethanol, 1,4-cyclohexanediol, dimer diols, bisphenol A, bisphenol F, hydrogenated bisphenol A, hydrogenated bisphenol F, glycerol, tetramethylene glycol, polytetramethylene glycol, 3-methyl-1,5-pentanediol, 1,9-nonanediol, 2-methyl-1,8-octanediol, trimethylolpropane, pentaerythritol, sorbitol, glucose, and combinations thereof.

Specific examples of useful amorphous polyester polyols, if present, include poly(hexanediol phthalate) polyol, poly(neopentyl glycol adipate) polyol, poly(neopentyl glycol phthalate) polyol, poly(neopentyl glycol hexanediol phthalate) polyol, poly(diethylene glycol phthalate) polyol, poly(ethylene glycol adipic acid terephthalate) polyol, polyethylene terephthalate polyols, random copolymer diols of ethylene glycol, hexane diol, neopentyl glycol, adipic acid and terephthalic acid, and combinations thereof.

Useful amorphous polyester polyols are commercially available under a variety of trade designations including, e.g., DYNACOLL 7110, 7130, 7140 and 7150 from Evonik Industries AG, and FLP PA-1000N from Xuchuan Chemical (Suzhou) Co., Ltd.

In some embodiments, the polyester polyols used in this invention can be liquid at room temperature, which provides wetting properties to the adhesive composition and impact resistance to the cured product. Accordingly, the liquid polyester polyol preferably has a glass transition temperature (Tg) of no larger than 0° C. If the Tg of the liquid polyester polyol is too high, it is more difficult to be in liquid status.

Examples of suitable liquid polyester polyols can be obtained by ring opening polymerization of a lactone such as ε-caprolactone and/or be derived from diols and diacids. Examples of diols useful in preparing preferred polyester polyols include ethylene glycol, diethylene glycol, 1,3-propylene glycol, 1,4-butanediol, 1,5-pentanediol, 1,6-hexanediol, 1,8-octanediol, 1,10-decanediol, and combinations thereof. Examples of diacids useful in preparing preferred polyester polyols include succinic acid, glutaric acid, adipic acid, suberic acid, azelaic acid, sebacic acid, and 1,12-dodecanedioic acid, dimer acid, and combinations thereof. Included within the scope of useful diacids are various diacid derivatives such as carboxylate esters (especially the methyl and ethyl esters), acid halides (such as acid chlorides) and acid anhydrides, and combinations thereof.

Specific examples of suitable liquid polyester polyols include poly(hexanediol adipate) polyol, poly(butanediol adipate) polyol, poly-epsilon-caprolactone polyol, poly(hexanediol dodecanedioate) polyol, poly(hexanediol adipic acid terephthalate) polyol, and mixtures thereof.

Suitable commercially available liquid polyester polyols are sold under the DYNACOLL 7200 series of trade designations from Evonik Industries AG including DYNACOLL 7210, 7230, 7231, 7250, etc and Stepan PDP 70 from Stepan Corporation.

Preferably, a combination of at least one crystalline polyester polyol, at least one amorphous polyester polyol and at least one liquid polyester polyol can be used as reactant (a) in the present invention.

In preferred embodiments, the reactant (a) has a number average molecular weight (Mn) of from 800 to 20,000 g/mol, preferably from 1,000 to 10,000 g/mol, and more preferably from 1,000 to 5,000 g/mol.

With particular preference, the reactant (a) may present in an amount of from 30% to 70% by weight, and more preferably from 35% to 65% by weight, based on the total weight of the adhesive composition.

### (b) Polyether Polyol

In some embodiments, the polyol mixture (A1) used in the present invention comprises (b) at least one polyether polyol.

The polyether polyols used in the present invention are well known to those skilled in the art. These polyether polyols are obtained by copolymerizing at least one compound of ethylene oxide, propylene oxide, butylene oxide, tetrahydrofuran, etc. with at least one compound having at least two active hydrogen atoms on average in one molecule such as the polyhydric alcohols list above which include ethylene glycol, propylene glycol, dipropylene glycol, glycerol, and combinations thereof. Other suitable polyhydric compounds include sucrose, ethylenediamine, propylenediamine, triethanolamine, 1,2-propanedithiol, and combinations thereof.

Preferred polyether polyols can be selected from polytetramethylene ether glycol, poly(oxypropylene) glycol, polyethylene oxide, polybuthylene oxide, and ethylene oxide endcapped versions of any of the foregoing, as well as the combinations thereof.

The most preferred polyether polyols are polytetramethylene ether glycol, poly(oxypropylene) glycol, ethylene oxide endcapped poly(oxypropylene)glycol, and combinations thereof.

In preferred embodiments, the polyether polyol has a number average molecular weight (Mn) of from 200 to 8,000 g/mol, preferably from 400 to 4,000 g/mol, and more preferably from 400 to 2,000 g/mol.

It is possible to use commercially available products in the present invention. Examples thereof include Voranol 2104, 2110, 2120 and 2140 from Dow Chemical Company.

With particular preference, the reactant (b) may present in an amount of from 10% to 40% by weight, and more preferably from 15% to 36% by weight, based on the total weight of the adhesive composition.

### (A2) Polyisocyanate

The moisture-curable polyurethane hot melt adhesive composition comprises at least one polyurethane prepolymer obtained by reacting a reactant mixture comprising (A1) a polyol mixture comprising: (a) at least one polyester polyol, and (b) at least one polyether polyol, and (A2) at least one polyisocyanate having at least two isocyanate groups in one molecule.

Useful polyisocyanates as reactant (A2) include any suitable isocyanate having at least two isocyanate groups in one molecule including, e.g., aliphatic, cyclopaliphatic, araliphatic, arylalkyl, and aromatic isocyanates, and combinations thereof.

Preferable reactant (A2) can be selected from 4,4-diphenylmethane diisocyanate (MDI), hydrogenated MDI (H12MDI), partly hydrogenated MDI (H6MDI), xylylene diisocyanate (XDI), tetramethylxylylene diisocyanate (TMXDI), 4,4-diphenyldimethylmethane diisocyanate, dialkylenediphenylmethane diisocyanate, tetraalkylenediphenylmethane diisocyanate, 4,4-dibenzyl diisocyanate, 1,3-phenylene diisocyanate, 1,4-phenylene diisocyanate, the isomers of toluylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane-1,4-diisocyanate, naphthalene-1,5-diisocyanate (NDI), butane-1,4-diisocyanate, hexane-1,6-diisocyanate (HDI), dicyclohexylmethane diisocyanate, 2,2,4-trimethylhexane-2,3,3-trimethylhexamethylene diisocyanate, cyclohexane-1,4-diisocyanate, ethylene diisocyanate, methylenetriphenyltriisocyanate (MIT), phthalic acid bisisocyanatoethyl ester, trimethylhexamethylene diisocyanate, 1,4-diisocyanatobutane, 1,12-diisocyanatododecane, and dimer fatty acid diisocyanate, lysine ester diisocyanate, 4,4-dicyclohexylmethane diisocyanate, 1,3-cyclohexane or 1,4-cyclohexane diisocyanate, and combinations thereof. The most preferred polyisocyanate is 4,4-diphenylmethane diisocyanate (MDI) and its isomers, chain-extended MDI, and combinations thereof.

Useful commercially available polyisocyanate used as reactant (A2) includes DESMODUR 44 C FUSED from Bayer, Desmodur 0118 I and Desmodur 44M from Covestro, Vannate MDI 100F from Wanhua Chemicals, Supresec 1809 from HUNTSMAN.

With particular preference, the reactant (A2) may be present in an amount of from 10% to 25% by weight, and preferably from 10% to 20% by weight, based on the total weight of the adhesive composition.

### (B) (Meth)Acrylic Polymer

According to the present invention, the moisture-curable polyurethane hot melt adhesive composition comprises (B) at least one (meth)acrylic polymer in an amount of no greater than 14% by weight based on the total weight of the adhesive composition which provides excellent initial cross tensile strength to the adhesive composition when cured.

The (meth)acrylic polymer used as component (B) in the present invention may be linear or branched and may consist of copolymerized alkyl functional (meth)acrylic monomers, acid functional (meth)acrylic monomers, tertiary amine functional (meth)acrylic monomers and may contain other functional groups that do not react rapidly with isocyanate functional groups. Branching in the (meth)acrylic polymer can be induced by copolymerizing a polyfunctional comonomer and/or using a polyfunctional chain transfer agent and/or a polyfunctional initiator.

Suitable comonomers used to form (meth)acrylic polymer of the present invention include the C1 to C12 esters of methacrylic and acrylic acids including, but not limited to methyl methacrylate, ethyl methacrylate, n-propyl, iso-propyl methacrylate, n-butyl methacrylate, isobutyl methacrylate, n-hexyl methacrylate, n-octyl methacrylate 2-ethylhexyl methacrylate, dodecyl (lauryl) methacrylate or the corresponding acrylates.

Mixtures of compatible (meth)acrylate monomers may also be used. Methacrylic and acrylic comonomers based on esters of methacrylic and acrylic acid with poly(ethylene glycol) and/or poly(propylene glycol and/or glycol ethers may also be used. Other additional vinyl comonomers that may be used include the vinyl esters (e.g. vinyl acetate and vinyl propionate); vinyl ethers; esters of crotonic acid, maleic acid, fumaric acid and itaconic acid; styrene; alkyl styrenes; acrylonitrile; butadiene; etc. as well as comonomers thereof. The particular monomers selected will depend, in large part, upon the end use for which the adhesives are intended.

Suitable acid functional comonomers used to form (meth)acrylic polymer of the present invention include, but are not limited to, methacrylic acid and acrylic acid.

Suitable hydroxyl functionalized comonomers used to form (meth)acrylic polymer of the present invention that can be incorporated include, but are not limited to, 2-hydroxyethylmethacrylate, 2-hydroxylpropyl methacrylate and 2-hydroxybutyl methacrylate or the corresponding acrylates.

Suitable amine functionalized comonomers used to form (meth)acrylic polymer of the present invention include, but are not limited to, dimethylaminoethyl methacrylate, diethylaminoethyl methacrylate or the corresponding acrylates.

The component (B) can be prepared by free-radical polymerization and molecular weight (Mn) is controlled by using a chain transfer agent, e.g. a thiol such as dodecyl mercaptan or catalytic chain transfer based on transition metal complexes. Branched (meth)acrylic polymers are made by copolymerizing a multifunctional monomer and/or using a multifunctional chain transfer agent and/or using a multifunctional initiator.

In preferred embodiments, the component (B) has a number average molecular weight (Mn) of from 5,000 to 100,000 g/mol, preferably from 5,000 to 80,000 g/mol, and more preferably from 8,000 to 50,000 g/mol.

Useful components (B) are commercially available, e.g. Elvacite 2013 from Lucite International.

According to the present invention, (meth)acrylic polymer shall be in an amount of no greater than 14% by weight based on the total weight of the adhesive composition, otherwise higher content of (meth)acrylic polymer is insoluble in the adhesive composition. With particular preference, the component (B) may be present in an amount of from 0.1% to 12% by weight, and preferably from 1% to 10% by weight, based on the total weight of the adhesive composition.

### (C) Amorphous Polyalphaolefin

According to the present invention, the moisture-curable polyurethane hot melt adhesive composition comprises (C) at least one amorphous polyalphaolefin having a softening point of less than 100° C. in an amount of no greater than 20% by weight, based on the total weight of the adhesive composition, providing an excellent initial cross tensile strength to the present adhesive composition when cured.

According to the present invention, component (C) has a softening point of less than 100° C. which is below the reaction temperature when preparing the present adhesive composition. If the amorphous polyalphaolefin has a softening point of no less than 100° C., the amorphous polyalphaolefin will precipitate during the reaction and forms granules in the adhesive composition. In preferred embodiments, the component (C) used in the present invention has a softening point of from 70° C. to 95° C.

In some embodiments, component (C) has a molecular weight (Mn) of less than 200,000 g/mol, preferably less than 100,000 g/mol.

In some embodiments, component (C) has a Brookfield viscosity no greater than 50,000 mPa-s, preferably less than 30,000 mPa-s at 190° C.

Useful amorphous polyalphaolefins used as component (C) in the present invention include polyalphaolefin homopolymers, copolymers, terpolymers and combinations thereof. The amorphous polyalphaolefins used as component (C) can be a random copolymer or a block copolymer. The said amorphous polyalphaolefins can be derived from a variety of monomers including, e.g., propylene, 1-butene, 1-pentene, 3-methyl-1-butene, 1-hexene, 3-methyl-1-pentene, 4-methyl-1-pentene, 3-ethyl-1-pentene, 1-octene, 1-decene, 1-undecene and combinations thereof.

Useful components (C) are commercially available under the Vestoplast 508 and Vestoplast 520 from Evonik Industrials.

According to the present invention, component (C) is present an amount of no greater than 20% by weight, based on the total weight of the adhesive composition. In preferred embodiments, component (C) used in the present invention is present in an amount of from 1% to 15% by weight, preferably from 1% to 8% by weight, based on the total weight of the adhesive composition. Using the component (C) having an amount of the above range is advantageous, because such amount of component (C) can provide excellent impact resistant performance to the adhesive composition while it does not derogate the initial cross tensile strength of the adhesive composition when cured.

### (D) Catalyst

Optionally, the moisture-curable polyurethane hot melt adhesive composition may also comprise a catalyst (D) to facilitate the reaction between the (A1) polyols and (A2) polyisocyanate having at least two isocyanate groups in one molecule.

Suitable components (D) include, for example, strongly basic amides, such as 2,3-dimethyl-3,4,5,6-tetrahydropyrimidine, tris-(dialkylaminoalkyl)-s-hexahydrotriazines, for example tris-(N,N-dimethylaminopropyl)-s-hexahydrotriazine or the usual tertiary amines, for example triethylamine, tributylamine, dimethylbenzylamine, N-ethyl-, N-methyl-, N-cyclo-hexylmorpholine, dimethylcyclohexylamine, dimorpholinodiethylether, 2-(dimethylaminoethoxy)-ethanol, 1,4diazabicyclo[2,2,2]octane, 1-azabicyclo[3,3,0]octane, N,N,N′,N′-tetramethyl ethylenediamine, N,N,N′,N′-tetramethyl butanediamine, N,N,N′,N′-tetramethyl hexane-1,6-diamine, pentamethyl diethylenetriamine, tetramethyl diaminoethylether, bis-(dimethylaminopropyl)-urea, N,N′-dimethylpiperazine, 1,2-dimethylimidazole, di-(4-N,N-dimethylaminocyclohexyl)-methane and the like and organometallic compounds, such as titanic acid esters, iron compounds, for example iron(III) acetyl acetonate, tin compounds, for example tin(II) salts of organic carboxylic acids, for example tin(II) diacetate, the tin(II) salt of 2-ethylhexanoic acid (tin(II) octoate), tin(II) dilaurate or the dialkyltin(IV) salts of organic carboxylic acids, for example dibutyltin(IV) diacetate, dibutyltin(IV) dilaurate, dibutyltin(IV) maleate or dioctyltin(IV) diacetate or the like, and dibutyltin(IV) dimercaptide or mixtures of two or more of the catalysts mentioned and synergistic combinations of strongly basic amines and organometallic compounds.

If present, the catalyst is present in the adhesive composition in an amount of from 0.05% to 1% by weight, and preferably from 0.05% to 0.5% by weight, based on the total weight of the adhesive composition.

### (E) Additives

Optionally, the moisture-curable polyurethane hot melt adhesive composition may comprise at least one additive. Such additive can be those commonly used in the art, such as colorants, antioxidants, etc.

Examples of colorants include pigments which may be selected from metal oxide pigments, titanium dioxide, optionally surface-treated, zirconium oxide or cerium oxide, zinc oxide, iron oxide (black, yellow or red), chromium oxide, manganese, and combinations thereof.

Examples of antioxidants include phenolic types such as BHT (butylated hydroxytoluene), octadecyl-3,5-bis(1,1-dimethyl)-4-hydroxybenzene-propanoate, and pyrogallol; phosphites such as triphenyl phosphite, tris(nonylphenyl)phosphite; or thioesters such as dilauryl thiodipropionate, and combinations thereof.

If present, the additive(s) may be present in an amount of from 0.01% to 1% by weight, and preferably from 0.05% to 0.5% by weight, based on the total weight of the adhesive composition.

### Adhesive Composition

In particular preferred embodiments, the moisture-curable polyurethane hot melt adhesive composition, based on the total weight of the adhesive composition, comprises:
from 66% to 99% by weight, preferably from 70% to 90% by weight of at least one polyurethane prepolymer obtained by reacting a reactant mixture comprising
   (A1) a polyol mixture comprising:
      (a) at least one polyester polyol, and
      (b) at least one polyether polyol, and
   (A2) at least one polyisocyanate having at least two isocyanate groups in one molecule;
no greater than 14% by weight, preferably from 0.1% to 12% by weight, and more preferably from 1% to 10% by weight of at least one (meth)acrylic polymer,
no greater than 20% by weight, preferably from 1% to 15% by weight, and more preferably from 1% to 8% by weight of at least one amorphous polyalphaolefin having a softening point of less than 100° C.,
from 0.05% to 1% by weight, preferably from 0.05% to 0.5% by weight of at least one catalyst, and
from 0.01% to 1% by weight, preferably from 0.05% to 0.5% by weight of at least one additive.

### Preparation Method

The moisture-curable polyurethane hot melt adhesive composition according to the present invention can be prepared by steps as follows to obtain the composition:
(i) mixing the reactant (A1), components (B) and (C) and optional (E) at a temperature from 120° C. to 140° C. and then vacuuming;
(ii) decreasing the temperature to from 80° C. to 100° C. and adding reactant (A2) and controlling the reaction temperature from 100 to 110° C.; and
(iii) optionally adding component (D) to mix to homogeneity.

The apparatuses for these mixing, stirring, dispersing, and the like are not particularly limited. There can be used an automated mortar, a Henschel mixer, a three-roll mill, a ball mill, a planetary mixer, a bead mill, and the like which are equipped with a stirrer and a heater. Also, an appropriate combination of these apparatuses may be used. The preparation method of the moisture-curable polyurethane hot melt adhesive composition is not particularly limited, as long as a composition in which the above-described components are uniformly mixed.

### Laminate and Electronic Device

According to a third aspect of the invention, provided herein is a laminate, comprising a first substrate, a second substrate, and an adhesive layer sandwiched therebetween, wherein the first and second substrates are independently of each other selected from a glass, a resin and a metal, and the adhesive layer being formed by curing the adhesive composition of the present invention.

The first substrate and/or second substrate can be of a single material and a single layer or can include multiple layers of the same or different material. The layers can be continuous or discontinuous.

The substrates of the article descried herein can have a variety of properties including rigidity (e.g., rigid substrates i.e., the substrate cannot be bent by an individual using two hands or will break if an attempt is made to bend the substrate with two hands), flexibility (e.g., flexible substrates i.e., the substrate can be bent using no greater than the force of two hands), porosity, conductivity, lack of conductivity, and combinations thereof.

The substrates of the article can be in a variety of forms including, e.g., fibers, threads, yarns, wovens, nonwovens, films (e.g., polymer film, metallized polymer film, continuous films, discontinuous films, and combinations thereof), foils (e.g., metal foil), sheets (e.g., metal sheet, polymer sheet, continuous sheets, discontinuous sheets, and combinations thereof), and combinations thereof.

In preferred embodiments, at least one of the substrates can be selected from metals, such as metal firing pastes, aluminum, tin, molybdenum, silver, conductive metal oxides such as indium tin oxide (ITO), fluorine doped tin oxide, aluminum doped zinc oxide etc, glasses such as inked glass, bare glass, resins such as polycarbonate, polybutylece terephthalate and polyamide. Further suitable metals include copper, gold, palladium, platinum, aluminum, indium, silver coated copper, silver coated aluminum, tin, and tin coated copper. Preferably both substrates are selected from one of the aforementioned materials.

The moisture-curable polyurethane hot melt adhesive composition of the present invention can cure at room temperature within the range of from 15° C. to 35° C. and 50% relative humidity for from 1 to 7 days.

As will be understood, the time and temperature curing profile for each moisture-curable polyurethane hot melt adhesive composition will vary, and different compositions can be designed to provide the curing profile that will be suited to the particularly industrial manufacturing process.

According to a fourth aspect of the invention, provided herein is an electronic device, comprising the laminate of the present invention or produced using the adhesive composition according to the present invention.

The moisture-curable polyurethane hot melt adhesive composition of the present invention can be applied to a substrate using any suitable application method including, e.g., automatic fine line dispensing, jet dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, and combinations thereof. The moisture-curable polyurethane hot melt adhesive composition can be applied as a continuous or discontinuous coating, in a single or multiple layers and combinations thereof.

### Use

According to a fifth aspect of the invention, provided herein is the use of the adhesive composition according to the present invention or the laminate according to the present invention in manufacturing electronic devices.

The said suitable electronic devices includes, but not limited to, e.g., wearable electronic devices (e.g., wrist watches and eyeglasses), handheld electronic devices (e.g., phones (e.g., cellular telephones and cellular smartphones), cameras, tablets, electronic readers, monitors (e.g., monitors used in hospitals, and by healthcare workers, athletes and individuals), watches, calculators, mice, touch pads, and joy sticks), computers (e.g., desk top and lap top computers), computer monitors, televisions, media players, or other electronic components.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials

VORANOL 2110 is polyether polyol having a number average molecular weight (Mn) of 1,000 g/mol, available from DOW.
Dynacoll 7360 is crystalline polyester polyol having a number average molecular weight (Mn) of 3,500 g/mol, available from Evonik Industries AG.
Dynacoll 7250 is liquid polyester polyol having a number average molecular weight (Mn) of 5,500 g/mol and glass transition temperature of −50° C., available from Evonik Industries AG.
Stepan PDP 70 is liquid diethylene glycol-phthalic anhydride-based modified polyester polyol having a number average molecular weight (Mn) of 1,600 g/mol, available from Stepan Corporation.
FLP PA-1000N is amorphous polyester polyol having a number average molecular weight (Mn) of 1,000 g/mol, available from Xuchuan Chemical (Suzhou) Co., Ltd.
Vestoplast 708 is amorphous polyalphaolefin having a softening point of 106±4° C., available from Evonik.
Vestoplast 408 is amorphous polyalphaolefin having a softening point of 118±4° C., available from Evonik.
Vestoplast 520 is amorphous polyalphaolefin having a softening point of 87±4° C., available from Evonik.
Vestoplast 508 is amorphous polyalphaolefin having a softening point of 84±4° C., available from Evonik.
Elvacite 2013 is (meth)acrylic polymer having a number average molecular weight (Mn) of 34,000 g/mol, available from Lucite International.
GRK 830 is carbon black paste, available from Spectrum Dispersions, Inc.
DESMODUR 44 C FUSED is MDI, available from Bayer.
JEFFCAT DMDEE is catalyst of 2,2′-dimorpholinildiethylether, available from HUNTSMAN.

### Preparation Method

### Example 1 (Ex.1)

19 g VORANOL 2110, 18.6 g Dynacoll 7250, 19.4 g Dynacoll 7360, 6 g Stepan PDP 70, 8 g FLP PA-1000N, 10 g Elvacite 2013, 1 g Vestoplast 508 and 1 g GRK 830 were added into a reactor and mixed 30 minutes at from 130 to 140° C., and then vacuum was decreased to less than 30 mBar for 2.5 hours. Afterwards, the temperature of the mixture was decreased to 95° C., and 16.6 g MDI was added and mixed at the temperature from 105° C. to 115° C. for another 80 minutes. Lastly, 0.4 g JEFFCAT DMDEE was added into the reactor and further mixed another 10 minutes. A homogeneous adhesive composition was obtained.

### Example 2 (Ex.2)

19 g VORANOL 2110, 18.6 g Dynacoll 7250, 19.4 g Dynacoll 7360, 6 g Stepan PDP 70, 8 g FLP PA-1000N, 10 g Elvacite 2013, 5 g Vestoplast 508 and 1 g GRK 830 were added into a reactor and mixed 30 minutes at from 130 to 140° C., and then vacuum was decreased to less than 30 mBar for 2.5 hours. Afterwards, the temperature of the mixture was decreased to 95° C., and 16.6 g MDI was added and mixed at the temperature from 105° C. to 115° C. for another 80 minutes. Lastly, 0.4 g JEFFCAT DMDEE was added into the reactor and further mixed another 10 minutes. A homogeneous adhesive composition was obtained.

### Example 3 (Ex.3)

19 g VORANOL 2110, 18.6 g Dynacoll 7250, 19.4 g Dynacoll 7360, 6 g Stepan PDP 70, 8 g FLP PA-1000N, 10 g Elvacite 2013, 3 g Vestoplast 508 and 1 g GRK 830 were added into a reactor and mixed 30 minutes at from 130 to 140° C., and then vacuum was decreased to less than 30 mBar for 2.5 hours. Afterwards, the temperature of the mixture was decreased to 95° C., and 16.6 g MDI was added and mixed at the temperature from 105° C. to 115° C. for another 80 minutes. Lastly, 0.4 g JEFFCAT DMDEE was added into the reactor and further mixed another 10 minutes. A homogeneous adhesive composition was obtained.

### Example 4 (Ex.4)

19 g VORANOL 2110, 18.6 g Dynacoll 7250, 19.4 g Dynacoll 7360, 6 g Stepan PDP 70, 8 g FLP PA-1000N, 10 g Elvacite 2013, 3 g Vestoplast 520 and 1 g GRK 830 were added into a reactor and mixed 30 minutes at from 130 to 140° C., and then vacuum was decreased to less than 30 mBar for 2.5 hours. Afterwards, the temperature of the mixture was decreased to 95° C., and 16.6 g MDI was added and mixed at the temperature from 105° C. to 115° C. for another 80 minutes. Lastly, 0.4 g JEFFCAT DMDEE was added into the reactor and further mixed another 10 minutes. A homogeneous adhesive composition was obtained.

### Example 5 (Ex.5)

19 g VORANOL 2110, 18.6 g Dynacoll 7250, 19.4 g Dynacoll 7360, 6 g Stepan PDP 70, 8 g FLP PA-1000N, 8 g Elvacite 2013, 5 g Vestoplast 508 and 1 g GRK 830 were added into a reactor and mixed 30 minutes at from 130 to 140° C., and then vacuum was decreased to less than 30 mBar for 2.5 hours. Afterwards, the temperature of the mixture was decreased to 95° C., and 16.6 g MDI was added and mixed at the temperature from 105° C. to 115° C. for another 80 minutes. Lastly, 0.4 g JEFFCAT DMDEE was added into the reactor and further mixed another 10 minutes. A homogeneous adhesive composition was obtained.

### Comparative Example 1 (CE.1)

19 g VORANOL 2110, 18.6 g Dynacoll 7250, 19.4 g Dynacoll 7360, 6 g Stepan PDP 70, 8 g FLP PA-1000N, 11 g Elvacite 2013 and 1 g GRK 830 were added into a reactor and mixed 30 minutes at from 130 to 140° C., and then vacuum was decreased to less than 30 mBar for 2.5 hours. Afterwards, the temperature of the mixture was decreased to 95° C., and 16.6 g MDI was added and mixed at the temperature from 105° C. to 115° C. for another 80 minutes. Lastly, 0.4 g JEFFCAT DMDEE was added into the reactor and further mixed another 10 minutes. A homogeneous adhesive composition was obtained.

### Comparative Example 2 (CE.2)

19 g VORANOL 2110, 18.6 g Dynacoll 7250, 19.4 g Dynacoll 7360, 6 g Stepan PDP 70, 8 g FLP PA-1000N, 10 g Elvacite 2013, 25 g Vestoplast 508 and 1 g GRK 830 were added into a reactor and mixed 30 minutes at from 130 to 140° C., and then vacuum was decreased to less than 30 mBar for 2.5 hours. Afterwards, the temperature of the mixture was decreased to 95° C., and 16.6 g MDI was added and mixed at the temperature from 105° C. to 115° C. for another 80 minutes. Lastly, 0.4 g JEFFCAT DMDEE was added into the reactor and further mixed another 10 minutes. A homogeneous adhesive composition could not be obtained as the amorphous polyalphaolefin having a weight percentage out of the range of the present invention was insoluble in the adhesive composition.

### Comparative Example 3 (CE.3)

19 g VORANOL 2110, 18.6 g Dynacoll 7250, 19.4 g Dynacoll 7360, 6 g Stepan PDP 70, 8 g FLP PA-1000N, 10 g Elvacite 2013, 3 g Vestoplast 408 and 1 g GRK 830 were added into a reactor and mixed 30 minutes at from 130 to 140° C., and then vacuum was decreased to less than 30 mBar for 2.5 hours. Afterwards, the temperature of the mixture was decreased to 95° C., and 16.6 g MDI was added and mixed at the temperature from 105° C. to 115° C. for another 80 minutes. Lastly, 0.4 g JEFFCAT DMDEE was added into the reactor and further mixed another 10 minutes. A homogeneous adhesive composition could not be obtained as the amorphous polyalphaolefin having a softening point out of the range of the present invention precipitated during the reaction and formed granules in the adhesive composition.

### Comparative Example 4 (CE.4)

19 g VORANOL 2110, 18.6 g Dynacoll 7250, 19.4 g Dynacoll 7360, 6 g Stepan PDP 70, 8 g FLP PA-1000N, 10 g Elvacite 2013, 3 g Vestoplast 708 and 1 g GRK 830 were added into a reactor and mixed 30 minutes at from 130 to 140° C., and then vacuum was decreased to less than 30 mBar for 2.5 hours. Afterwards, the temperature of the mixture was decreased to 95° C., and 16.6 g MDI was added and mixed at the temperature from 105° C. to 115° C. for another 80 minutes. Lastly, 0.4 g JEFFCAT DMDEE was added into the reactor and further mixed another 10 minutes. A homogeneous adhesive composition could not be obtained as the amorphous polyalphaolefin having a softening point out of the range of the present invention precipitated during the reaction and formed granules in the adhesive composition.

### Comparative Example 5 (CE.5)

19 g VORANOL 2110, 18.6 g Dynacoll 7250, 19.4 g Dynacoll 7360, 6 g Stepan PDP 70, 8 g FLP PA-1000N, 3 g Vestoplast 508 and 1 g GRK 830 were added into a reactor and mixed 30 minutes at from 130 to 140° C., and then vacuum was decreased to less than 30 mBar for 2.5 hours. Afterwards, the temperature of the mixture was decreased to 95° C., and 16.6 g MDI was added and mixed at the temperature from 105° C. to 115° C. for another 80 minutes. Lastly, 0.4 g JEFFCAT DMDEE was added into the reactor and further mixed another 10 minutes. A homogeneous adhesive composition was obtained.

### Comparative Example 6 (CE.6)

19 g VORANOL 2110, 18.6 g Dynacoll 7250, 19.4 g Dynacoll 7360, 6 g Stepan PDP 70, 8 g FLP PA-1000N, 15 g Elvacite 2013, 3 g Vestoplast 508 and 1 g GRK 830 were added into a reactor and mixed 30 minutes at from 130 to 140° C., and then vacuum was decreased to less than 30 mBar for 2.5 hours. Afterwards, the temperature of the mixture was decreased to 95° C., and 16.6 g MDI was added and mixed at the temperature from 105° C. to 115° C. for another 80 minutes. Lastly, 0.4 g JEFFCAT DMDEE was added into the reactor and further mixed another 10 minutes. A homogeneous adhesive composition could not be obtained as the (meth)acrylic polymer having a weight percentage out of the range of the present invention was insoluble in the adhesive composition.

### Test Methods

### Initial Cross Tensile Strength:

### Sample Preparation:

I. Firstly, polycarbonate substrate with 20% by weight of glass fiber which in a size of 101.6×25.4×1 mm and an ink glass which in size of 101.6*25.4*3 mm were prepared. The substrates were cleaned with isopropanol and idled at ambient conditions for several minutes to make sure the surface was completely dry. The polycarbonate substrate and the ink glass substrate were placed crosswise, and the overlapping area was to be formed an adhesive layer sandwiched therebetween.
II. Then, two spacers with diameter of 0.127 mm were set up to control the thickness of the adhesive layer. Before dispersing the adhesive composition, the said spacers were placed at the edge of ink glass with a distance of 3 mm from the edge of the overlapping area.
III. After that, the adhesive composition was heated in Loctite 400D dispense machine to 110° C. for 30 minutes. A needle in 21 #size was used for dispensing the adhesive composition to the surface of the ink glass. During the dispensing process, two bond lines were formed by adhesive beads dispensed through the needle. The two bond lines were applied parallelly and each one had a distance of from 1 to 1.5 mm to the edge of the overlapping area of the two substrates. Furthermore, the distance between each adhesive bead were controlled at 8 mm, and the distance from the adhesive bead to the edge of the overlapping area of the two substrates was also 8 mm.
IV. After dispensing, the polycarbonate substrates with 20% by weight of glass fiber were pressed on it to form a sandwich construction of the overlapping area while leaving two free ends of each substrate. Then the laminate was prepared.
V. A 2-kilogram weight was applied to the sandwich construction of the overlapping area for 15 seconds. Then the weight was removed, and the resulting samples were placed at 23° C. and 50% relative humidity for 1 hour to cure the adhesive composition.

Sample Testing: To determine the initial cross tensile strength at break of an adhesive layer, the cross tensile strength of the samples was measured by INSTRON tensile tester with a test speed of 10 mm/min. If the initial cross tensile strength is larger than 2.5 MPa, the adhesive composition is suitable for the use in the electronic devices.

### Du Pont Impact Energy Test:

The impact resistance of the cured adhesive composition was evaluated by Du Pont impact energy using a lap-shear assembly.

### Sample Preparation:

I. Firstly, a polycarbonate substrate with 20% by weight of glass fiber which in a size of 101.6×25.4×1 mm, a magnesium aluminum alloy substrate which is in a size of 1 inch width*4 inches length with a hole having a diameter of 10 mm in the center and a polyethylene terephthalate (PET) film with a hole having a diameter of 12 mm in the center and 0.12 mm thickness were prepared. The PET film has a tape on one surface for bonding to the magnesium aluminum alloy substrate in order to control the adhesive layer's width and thickness. The substrates were cleaned with isopropanol and idled at ambient conditions for several minutes to make sure the surface was completely dry.
II. The PET film was bonded to the magnesium aluminum alloy substrate, to make sure the position of the centric hole in PET film faced with the position of the centric hole in the magnesium aluminum alloy substrate. The diameter of the magnesium aluminum alloy substrate was 2 mm larger than the PET film, which forms a circular ring area in a width of 1 mm.
III. The adhesive composition was dispensed within the said circular ring area on the magnesium aluminum alloy substrate, and then the polycarbonate substrate was placed crosswise to cover the centric hole of the magnesium aluminum alloy substrate, and the overlapping area, i.e., the circular ring area was to be formed an adhesive layer in a width of 1 mm and a thickness of 0.12 mm sandwiched therebetween.
IV. The specimen was cured under 23° C. and a humidity of 60% for 72 hours.
V. The specimen was fixed in the holder at the base of a Dupont tester (BGD301) for testing.

### Sample Testing:

A 50 g weight was dropped on the specimen from a height of 2 cm as a starting point. If the magnesium aluminum alloy substrate was not peeled from the polycarbonate substrate for 3 times, then the weight was raised to a height of 2 cm higher than the previous height to drop. If the magnesium aluminum alloy substrate was not peeled from the polycarbonate substrate using a 50 g weight at the height of 50 cm, then a 60 g weight was used to conduct the test. The Du Pont impact energy was calculated using the following equation:

$$E = m * g * h * 0.01 ,$$

wherein E is impact energy (mJ), m is weight (g) when substrates were peeled from each other, h is the height (cm) of the weight loosed from when substrates were peeled from each other, g is 9.8 m/s². The Du Pont impact energy value of less than 350 mJ is considered as an unacceptable impact resistance.

The test results are shown in Table 1.

| | CE.1 | CE.5 | EX.1 | EX.2 | EX.3 | EX.4 | EX.5 |
|---|---|---|---|---|---|---|---|
| Initial cross | 3.44 | 1.34 | 3.21 | 3.42 | 3.35 | 3.69 | 2.93 |
| tensile | | | | | | | |
| strength | | | | | | | |
| (MPa) | | | | | | | |
| Du Pont | 294 | 478 | 354 | 369 | 383 | 365 | 392 |
| impact | | | | | | | |
| energy | | | | | | | |
| (mJ) | | | | | | | |

As can be seen from Table 1, the moisture-curable polyurethane hot melt adhesive compositions of the present invention exhibited excellent impact resistance and initial cross tensile strength when cured, while the comparative composition showed unsatisfactory performance.

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A moisture-curable polyurethane hot melt adhesive composition comprising:
(A) at least one polyurethane prepolymer that is the reaction product of a reactant mixture comprising
(A1) a polyol mixture comprising:
(a) at least one polyester polyol, and
(b) at least one polyether polyol, and
(A2) at least one polyisocyanate having at least two isocyanate groups in one molecule;
(B) at least one (meth)acrylic polymer present in an amount of no greater than 14% by weight based on the total weight of the adhesive composition, and
(C) at least one amorphous polyalphaolefin having a softening point of less than 100° C., present in an amount of no greater than 20% by weight, based on the total weight of the adhesive composition.

2. The moisture-curable polyurethane hot melt adhesive composition according to claim 1, wherein the (a) at least one polyester polyol is selected from crystalline polyester polyol, amorphous polyester polyol, liquid polyester polyol, and combinations thereof.

3. The moisture-curable polyurethane hot melt adhesive composition according to claim 1, wherein the (a) at least one polyester polyol has a number average molecular weight (Mn) of 800 to 20,000 g/mol.

4. The moisture-curable polyurethane hot melt adhesive composition according to claim 1, wherein the (b) at least one polyether polyol is selected from polytetramethylene ether glycol, poly(oxypropylene) glycol, polyethylene oxide, polybutylene oxide, ethylene oxide endcapped versions of any of the foregoing, and combinations thereof.

5. The moisture-curable polyurethane hot melt adhesive composition according to claim 1, wherein the (A2) at least one polyisocyanate is selected from 4,4-diphenylmethane diisocyanate (MDI), hydrogenated MDI (H12MDI), partly hydrogenated MDI (H6MDI), xylylene diisocyanate (XDI), tetramethylxylylene diisocyanate (TMXDI), 4,4-diphenyldimethylmethane diisocyanate, dialkylenediphenylmethane diisocyanate, tetraalkylenediphenylmethane diisocyanate, 4,4-dibenzyl diisocyanate, 1,3-phenylene diisocyanate, 1,4-phenylene diisocyanate, isomers of toluylene diisocyanate (TDI), 1-methyl-2,4-diisocyanatocyclohexane, 1,6-diisocyanato-2,2,4-trimethylhexane, 1,6-diisocyanato-2,4,4-trimethylhexane, 1-isocyanatomethyl-3-isocyanato-1,5,5-trimethylcyclohexane (IPDI), tetramethoxybutane-1,4-diisocyanate, naphthalene-1,5-diisocyanate (NDI), butane-1,4-diisocyanate, hexane-1,6-diisocyanate (HDI), dicyclohexylmethane diisocyanate, 2,2,4-trimethylhexane-2,3,3-trimethylhexamethylene diisocyanate, cyclohexane-1,4-diisocyanate, ethylene diisocyanate, methylenetriphenyltriisocyanate (MIT), phthalic acid bisisocyanatoethyl ester, trimethylhexamethylene diisocyanate, 1,4-diisocyanatobutane, 1,12-diisocyanatododecane, and dimer fatty acid diisocyanate, lysine ester diisocyanate, 4,4-dicyclohexylmethane diisocyanate, 1,3-cyclohexane or 1,4-cyclohexane diisocyanate, and combinations thereof.

6. The moisture-curable polyurethane hot melt adhesive composition according to claim 1, wherein the (B) at least one (meth)acrylic polymer has a number average molecular weight (Mn) of 5,000 to 100,000 g/mol.

7. The moisture-curable polyurethane hot melt adhesive composition according to claim 1, wherein the (C) at least one amorphous polyalphaolefin has a softening point of from 70° C. to 95° C.

8. The moisture-curable polyurethane hot melt adhesive composition according to claim 1, wherein the (C) at least one amorphous polyalphaolefin has a molecular weight (Mn) of less than 200,000 g/mol.

9. The moisture-curable polyurethane hot melt adhesive composition according to claim 1, wherein the adhesive composition further comprises at least one catalyst (D) selected from strongly basic amides, triethylamine, tributylamine, dimethylbenzylamine, N-ethyl-, N-methyl-, N-cyclo-hexylmorpholine, dimethylcyclohexylamine, dimorpholinodiethylether, 2-(dimethylaminoethoxy)-ethanol, 1,4-diazabicyclo[2,2,2]octane, 1-azabicyclo[3,3,0]octane, N,N,N′,N′-tetramethyl ethylenediamine, N,N,N′,N′-tetramethyl butanediamine, N,N,N′,N′-tetramethyl hexane-1,6-diamine, pentamethyl diethylenetriamine, tetramethyl diaminoethylether, bis-(dimethylaminopropyl)-urea, N,N′-dimethylpiperazine, 1,2-dimethylimidazole, di-(4-N,N-dimethylaminocyclohexyl)-methane, organometallic compounds, and combinations thereof.

10. The moisture-curable polyurethane hot melt adhesive composition according to claim 1, wherein the adhesive composition further comprises (E) at least one additive.

11. The moisture-curable polyurethane hot melt adhesive composition according to claim 1, wherein the (A) at least one polyurethane prepolymer is present in an amount of from 66% to 99% by weight, based on the total weight of the adhesive composition.

12. The moisture-curable polyurethane hot melt adhesive composition according to claim 1, wherein the (a) at least one polyester polyol is present in an amount of from 30% to 70% by weight, based on the total weight of the adhesive composition.

13. The moisture-curable polyurethane hot melt adhesive composition according to claim 1, wherein the (b) at least one polyether polyol is present in an amount of from 10% to 40% by weight, based on the total weight of the adhesive composition.

14. The moisture-curable polyurethane hot melt adhesive composition according to claim 1, wherein the (A2) at least one polyisocyanate is present in an amount of from 10% to 25% by weight, based on the total weight of the adhesive composition.

15. The moisture-curable polyurethane hot melt adhesive composition according to claim 1, wherein the (B) at least one (meth)acrylic polymer is present in an amount of from 0.1% to 12% by weight, based on the total weight of the adhesive composition.

16. The moisture-curable polyurethane hot melt adhesive composition according to claim 1, wherein the (C) at least one amorphous polyalphaolefin is present in an amount of from 1% to 15% by weight, based on the total weight of the adhesive composition.

17. The moisture-curable polyurethane hot melt adhesive composition according to claim 1, further comprising at least one catalyst (D) selected from strongly basic amides, triethylamine, tributylamine, dimethylbenzylamine, N-ethyl-, N-methyl-, N-cyclo-hexylmorpholine, dimethylcyclohexylamine, dimorpholinodiethylether, 2-(dimethylaminoethoxy)-ethanol, 1,4-diazabicyclo[2,2,2]octane, 1-azabicyclo[3,3,0]octane, N,N,N′,N′-tetramethyl ethylenediamine, N,N,N′,N′-tetramethyl butanediamine, N,N,N′,N′-tetramethyl hexane-1,6-diamine, pentamethyl diethylenetriamine, tetramethyl diaminoethylether, bis-(dimethylaminopropyl)-urea, N,N′-dimethylpiperazine, 1,2-dimethylimidazole, di-(4-N,N-dimethylaminocyclohexyl)-methane, organometallic compounds, and combinations thereof; wherein the (D) catalyst is present in an amount of from 0.05% to 1% by weight, based on the total weight of the composition.

18. A method for preparing a hot melt adhesive composition according to claim 1, comprising the steps:
(i) mixing the reactant (A1), components (B) and (C) and optionally (E) at least one additive at a temperature from 120° C. to 140° C. and then vacuuming;
(ii) decreasing the temperature to from 80° C. to 100° C. and adding reactant (A2) and controlling the reaction temperature from 100 to 110° C.; and
(iii) optionally adding (D) at least one catalyst and mixing to homogeneity.

19. A laminate, comprising a first substrate, a second substrate, and an adhesive layer sandwiched therebetween, wherein the first and second substrates are independently of each other selected from a glass, a resin and a metal, and the adhesive layer being formed by cured reaction products of the adhesive composition according to claim 1.

20. An electronic device, comprising the adhesive composition according to claim 1.
